(19) United States
(12) Patent Application Publication
(10) Pub. No.: US 2017/0136386 A1
(43) Pub. Date: May 18, 2017

(54) Methods for Treating Industrial Waste Streams and Recovering Certain Chemical Compounds

(71) Applicants: Stephen R. Temple, Santa Curz, CA (US); Howard Everett Whitney, Felton, CA (US)

(72) Inventors: Stephen R. Temple, Santa Curz, CA (US); Howard Everett Whitney, Felton, CA (US)

(21) Appl. No.: 15/352,068

(22) Filed: Nov. 15, 2016

Related U.S. Application Data
(60) Provisional application No. 62/304,049, filed on Mar. 4, 2016.
(60) Provisional application No. 62/255,521, filed on Nov. 15, 2015.

(51) Int. Cl. B01D 5/00; B01D 3/26; B01D 53/58; A22C 18/00; B01D 53/73; B01D 53/14; B01D 47/10; C05B 7/00; B01D 53/00; B01D 53/78

(52) U.S. Cl. CPC B01D 5/009; B01D 53/002; B01D 5/0063; B01D 3/26; B01D 53/58; B01D 53/78; B01D 53/73; B01D 53/1418; B01D 53/145; B01D 47/10; C05B 7/00; A22C 18/00

(57) ABSTRACT

The invention relates to methods and equipment for treating industrial vapor and liquid waste streams to remove certain compounds and concentrate those compounds to produce a chemical product. Specifically, the invention related to methods and equipment for condensing vapor waste streams and combining those streams with other liquid waste streams, and processing those combined streams to separate certain compounds for further processing into a chemical product, such as a fertilizer, and to thereby to reduce pollution, odor, and nutrient loading to air and water resources and wastewater processing systems.

### CROSS-REFERENCE TO RELATED APPLICATIONS

This application claims the benefit of provisional Application Nos. 62/304,049, filed Mar. 4, 2016, and 62/255,521, filed Nov. 15, 2015. The entirety of each of the foregoing applications is incorporated by reference herein.

### BACKGROUND OF THE INVENTION

### Field of the Invention

The invention relates to various methods for treating various liquid and vapor phase waste streams from industrial processes to recover certain chemical components and producing a chemical product. In particular, the invention relates to various methods for condensing vapor streams and aggregating the resulting condensate with other condensate and liquid streams for the purpose of treating these streams to concentrate a particular chemical into a marketable chemical product as part of an integrated air pollution, odor, and wastewater treatment process in various industrial processes, such as rendering.

### Description of Related Art

Control of pollution, odors, and nutrient loading to both air and water resources is a challenging problem faced by many industries, such as the animal byproduct processing industry, referred to as rendering. In most rendering facilities, animal byproduct is brought into the processing facility and processed, in some cases, into animal feed. The process converts the byproduct, which consists of animal tissue waste, into stable value-added material like purified animal fats (lard, tallow, and grease), gelatins (alkaline, acid, cold soluble and hydrosylates), specialty protein derivatives (peptides, amino acids) and protein meals (meat, feather meal, hair meal, wool meal, bone meal, and blood meal).

Generally, the rendering process is performed by separating fat from the bone and protein and processing the resulting fat and solids to produce fat-based products and meal products, respectively. In some cases, the animal tissue may be blended with other organic material to form feeds. In some cases the animal byproduct includes blood, feathers, wool and hair, and the processing of these materials includes hydrolyzing and drying the material to form blood meal, feather meal, wool meal and a hair meal.

However, the rendering process involves many steps, some of which result in the generation of vapor and liquid streams that contain compounds, and some of which contain compounds in different phases, that contribute to pollution, odors, and nutrient loading in the environment. The following is an example of some, but not all, of the rendering process steps that create waste streams. First, the raw material is brought to the plant in trucks and staged for input to a raw material conveyor that transports the material to a raw material grinder. The resulting raw animal byproduct is a commingled gas, liquid, and/or solid waste that is typically contained by a room air ventilation system that is vented to breathing spaces and/or the atmosphere or treated by a number of methods (e.g. scrubbing). The raw animal byproduct is then “cooked” in a continuous or batch cooker (e.g., disk dryer, evaporators, hydrolyzer) through the addition of heat to evaporate moisture and to separate fat from bone and protein. The resulting material is then separated into liquid fat and solids.

During cooking, various vapor streams may be generated that comprise odorous, noxious, hazardous, toxic, mutagenic, and/or carcinogenic compounds and/or precursor compounds that may convert to odorous, noxious, hazardous, toxic, mutagenic, and/or carcinogenic compounds. In addition, these vapor streams may have components in different phases such that the vapor stream, although predominantly a gas or vapor, has commingled gas, liquid, and/or solid phases. In addition, the cooking process may produce smoke, solid particulates, volatile organic compounds (“VOCs”), other volatile compounds such as hydrogen sulfide and ammonia and/or ammonium, semi-volatile organic compounds (“SVOCs”), aerosolized fats, oils, greases, tallow, and wax and water vapor.

After cooking, the solids are processed to remove additional moisture and fats (e.g., by using a screw press) resulting in the generation of a press cake that is ultimately made into a meal product. The screw press adds frictional heating and mechanical mixing while containing heat from the cooking process, which also may produce similar vapor waste streams as those generated during cooking. Solids generated in the screw press are subject to additional frictional heating within the auger that transports the solids to a grinder, which grinds the solids, as well as within the grinder itself, which may involve a multi-stage grinding process. This frictional heating also may evolve waste smoke, solid particulates, VOCs, other volatiles such as hydrogen sulfide and ammonia and/or ammonium, SVOCs, aerosolized fats, oils, greases, tallow, and wax and water vapor.

The fat separated by the screw press, which may comprise liquid fat and/or fat-liquid-solid slurries, is processed to remove additional gases, liquids, and/or solids (e.g., by using an evaporator system followed by a centrifuge of the fats) resulting in a liquid fat product that can be further processed into fat-based products. The evaporator and centrifuge processes involve heating under vacuum to boil off vapors, mechanical mixing, and aeration, noting that the fat still contains heat from the cooking process, all of which also results in the creation of a vapor waste stream.

Accordingly, generation of vapor waste streams having commingled gas, liquid, and/or solid phases can occur at several points in the rendering process, including, but not limited to, unloading, conveyance, crushing, cooking, screw press operation, auger conveyance, grinding, evaporator operation, and centrifuge operation. These vapor multi-phase waste streams may contain solid organic and inorganic particulates, smoke particulates, aerosolized oils greases, tallows, waxes and water vapor having odorous, noxious, hazardous, toxic, mutagenic, and/or carcinogenic compounds and/or precursor compounds and/or nutrient (including, but not limited to ammonia and/or ammonium) compounds such as hydrogen sulfide, ammonia and/or ammonium, carboxylic acids, esters, alcohols, ketones, aldehydes, amines, mercaptans, alkenes, furans, pyrazines, pyrroles, thiazoles, pyridine and other VOCs and SVOCs.

In most facilities a gaseous odor control system is used to reduce or remove some of these compounds from these vapor waste streams. However, such systems may not remove enough of the compounds. In many instances, these vapor waste streams are incinerated; however, the various methods of incineration do not necessarily address particulate removal issues (e.g. PM2.5 and PM10); lose efficiency due to corrosive and erosive vapor; increase maintenance; reduce equipment service life; produce air pollution and ozone precursors (e.g. nitrogen oxides (NOₓ), sulfur oxide (SOₓ)); can have a significant carbon footprint due to burning of natural gas and petroleum fuels for the incinerator, and be expensive to construct and operate.

In addition, the rendering process also produces various liquid waste streams that may contain various compounds that are problematic upon release. For example, nutrients release by these streams to surface water and groundwater can lead to overgrowth of algae leading to harmful and toxic algae blooms and excess nitrogen in water.

Therefore, there is a need for a method of removing pollutant, odor, and/or nutrient (including, but not limited to ammonia and/or ammonium) compounds, and/or precursor compounds, from vapor and liquid waste streams produced in industrial processes, such as rendering, biofuel manufacturing, animal byproduct manufacturing, and pet food processing, as well as other industries that produce liquid and vapor waste streams containing odorous, noxious, hazardous, toxic, mutagenic, carcinogenic, or nutrient (including, but not limited to ammonia and/or ammonium) compounds and/or precursor compounds, including streams that contain components in various phases, that can be condensed and/or aggregated and treated to concentrate particular chemicals or compounds and produce a useable product, such as a marketable chemical product such as a fertilizer. Further, there is a need for such a method to be an integrated and synergistic air and water treatment process.

### BRIEF SUMMARY OF THE INVENTION

The invention and its various embodiments relate to methods and equipment for treating various liquid and vapor waste streams generated at a wide variety of industrial, commercial, and environmental processes, including, but not limited to, animal rendering, pet food manufacturing, food processing, food cooking, energy generation, biofuel manufacturing, indoor air pollution control, environmental remediation and mitigations, refining, petrochemical, chemical manufacturing, machining, printing, electronics, wood products, textiles, pulp and paper. In particular, the invention and its various embodiments relates to treating liquid and waste streams that contain odorous, noxious, hazardous, toxic, mutagenic, and/or carcinogenic compounds and/or precursor compounds and that may contain various phases, such as a vapor stream having commingled gas, liquid, and/or solid phases.

More specifically, the invention and its various embodiments relate to methods for condensing odorous, noxious, hazardous, toxic, mutagenic, and/or carcinogenic compounds and/or precursor compounds contained in multi-phase vapor waste streams having chemical vapors, solid particulates, smoke particulates, aerosols, and/or water vapor using synergistic serial combinations of gas treatment processes specifically tasked to remove each type and phase of matter including, but not be limited to, staged condensation from near ambient to cryogenic temperatures, all manner and type of particulate removal, and/or numerous wet scrubbing techniques. These treated and condensed waste streams are combined, along with other liquid waste streams, for further treatment to concentrate certain compounds or chemicals and to produce a marketable chemical product, such as a fertilizer, from those concentrated compounds.

In some embodiments, the invention relates to methods and apparatuses for creating and/or treating and/or concentrating a condensate stream from wet scrubber blow down, spray venturi blow down, hair and feather hydrolyser condensate, cooker and evaporator condensate, blood serum, and any other process streams containing ammonia, ammonium, and/or total kjeldahl nitrogen in a rendering process upstream from waste water treatment and/or pre-treatment. Because the various condensate streams generated in a rendering process contain a significant amount of odorous, pollutant, and nutrient loading compounds, these condensate streams can be the principle cause of odor, pollution, and nutrient problems in the surrounding atmosphere. Accordingly, in one embodiment, a method for reducing odorous, pollutant, and nutrient loading compounds in a condensate stream from a rendering process comprises condensing a vapor stream containing odorous, noxious, hazardous, toxic, mutagenic, and/or carcinogenic compounds and/or precursor compounds and/or nutrient (including, but not limited to ammonia and/or ammonium) compounds in a rendering process to produce a liquid condensate stream comprising odorous, pollutant and nutrient loading compounds and concentrating the created condensate stream and optionally one or more other liquid waste streams into a liquid chemical product, such as a fertilizer.

In one embodiment, a series of strippers and scrubbers are used, which may require heating and/or cooling and/or gross filtering and/or membrane filtering and/or osmotic steps integrated into the process. In another embodiment, a series of reflux condensers and/or tube and shell condensers and/or dry condensers are used, which may require heating and/or cooling and/or gross filtering and/or membrane filtering and/or osmotic steps integrated into the process. In another embodiment, a series of strippers and scrubbers combined and integrated with reflux condensers and/or tube and shell condensers and/or dry condensers are used.

In another embodiment, a method for reducing odorous, pollutant, and nutrient loading compounds in a condensate stream from a rendering process comprises condensing a vapor stream containing odorous, noxious, hazardous, toxic, mutagenic, and/or carcinogenic compounds and/or precursor compounds and/or nutrient (including, but not limited to ammonia and/or ammonium) compounds in a rendering process to produce a liquid condensate stream comprising odorous, pollutant, and nutrient loading compounds condensed from said vapor stream and concentrating the created condensate stream and possibly one or more other existing liquid dominated waste streams in order to precipitate crystalline magnesium ammonium phosphate, or struvite, for the recovery of nutrients from vapor condensate and liquid waste streams.

As a result of processing the vapor condensate and/or other liquid waste streams as described in the various embodiments of the invention, the odorous, pollutant, and nutrient loading compounds are separated and concentrated, thereby creating a liquid chemical product, such as a fertilizer, that can be easily stored, sold, and transported offsite for use in the agricultural industry. The concentrated condensate and/or liquid waste streams thereby contain less odor, pollutant, and nutrient sources and place a lower burden on the air pollution and odor control system and on the atmosphere and/or breathing spaces. In addition, the invention and its various embodiments also reduces the loading of odorous, pollutant, and nutrient (including, but not limited to ammonia and/or ammonium) compounds to a wastewater treatment system, an industrial wastewater treatment system or similar system, or a publicly owned wastewater treatment works (POTW), as well as to surface water and groundwater.

BRIEF DESCRIPTION OF THE SEVERAL VIEWS OF THE DRAWINGS

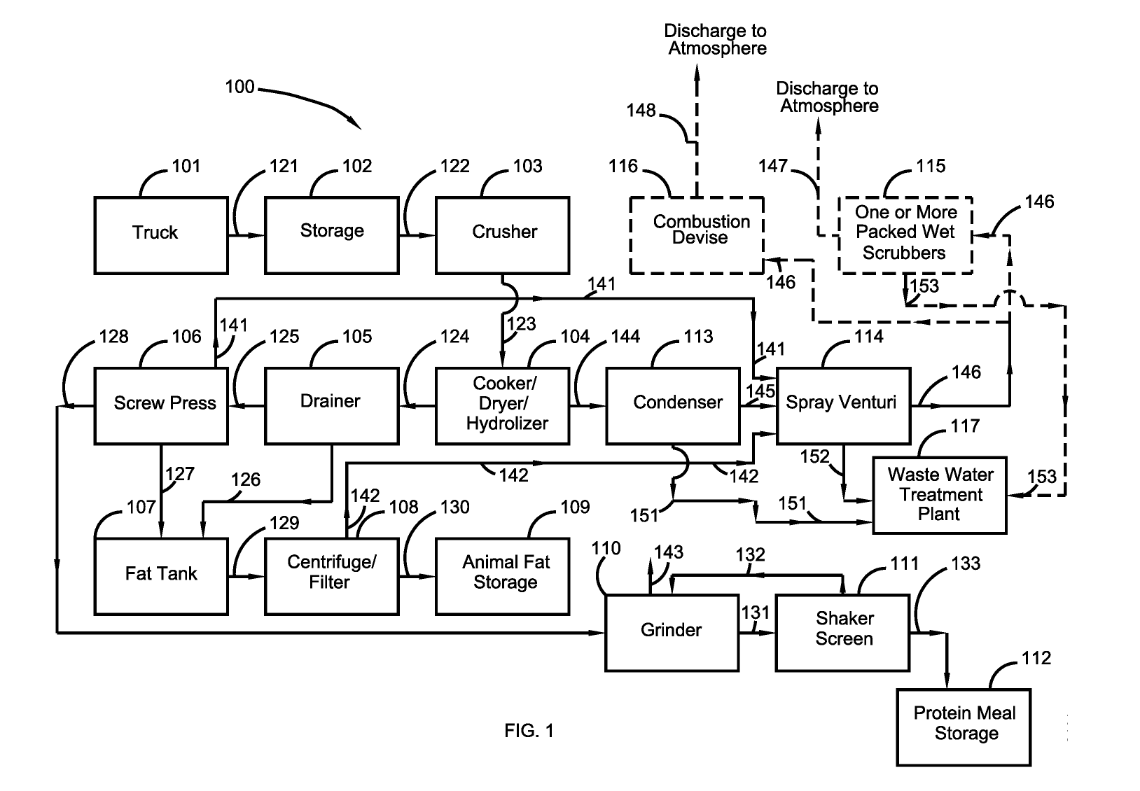

FIG. 1 is a flow diagram for a typical rendering process;

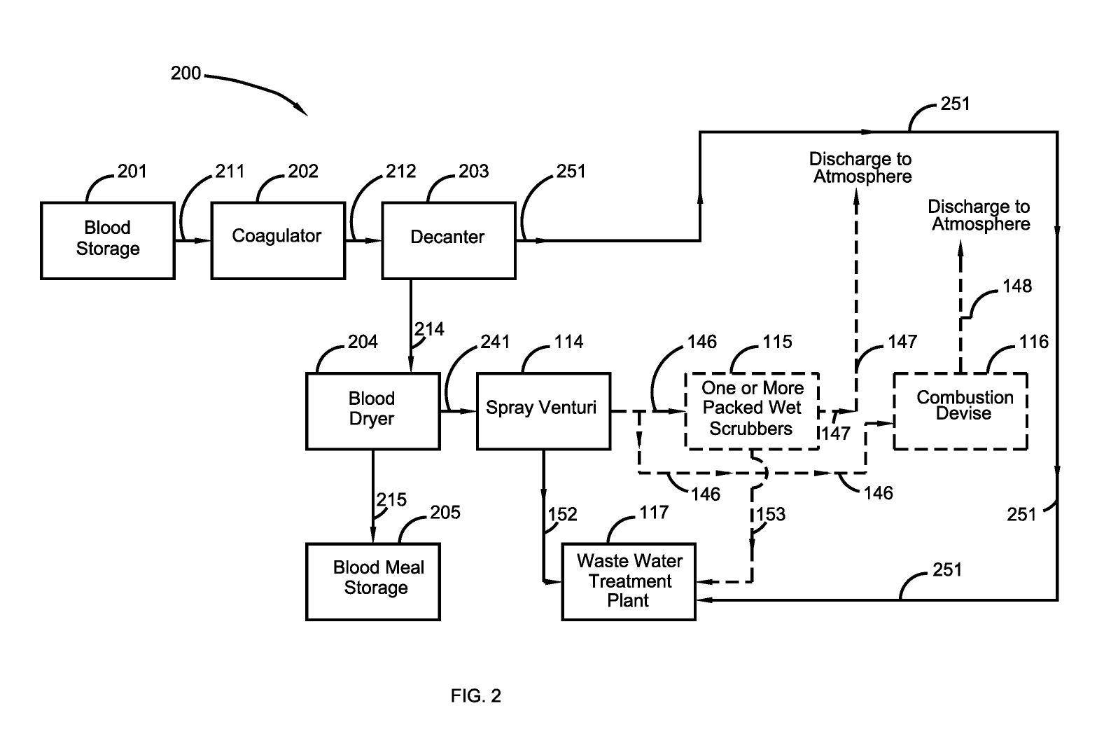

FIG. 2 is a flow diagram for a typical blood rendering process;

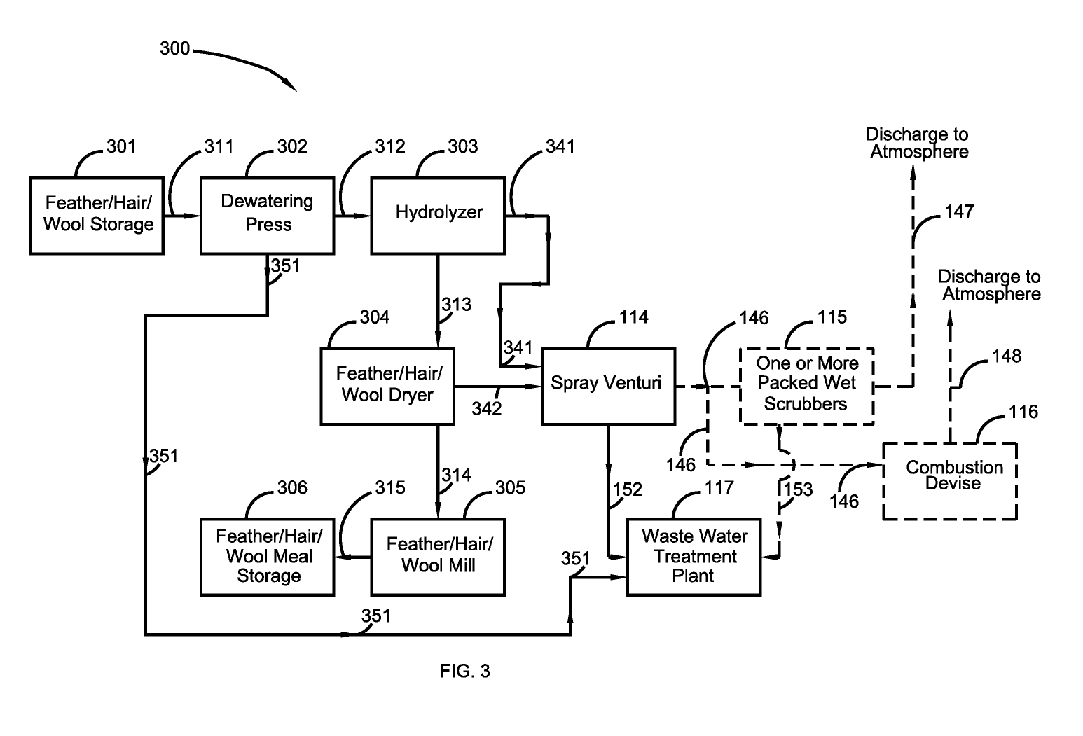

FIG. 3 is a flow diagram for a typical poultry feather, animal hair, or animal wool rendering process;

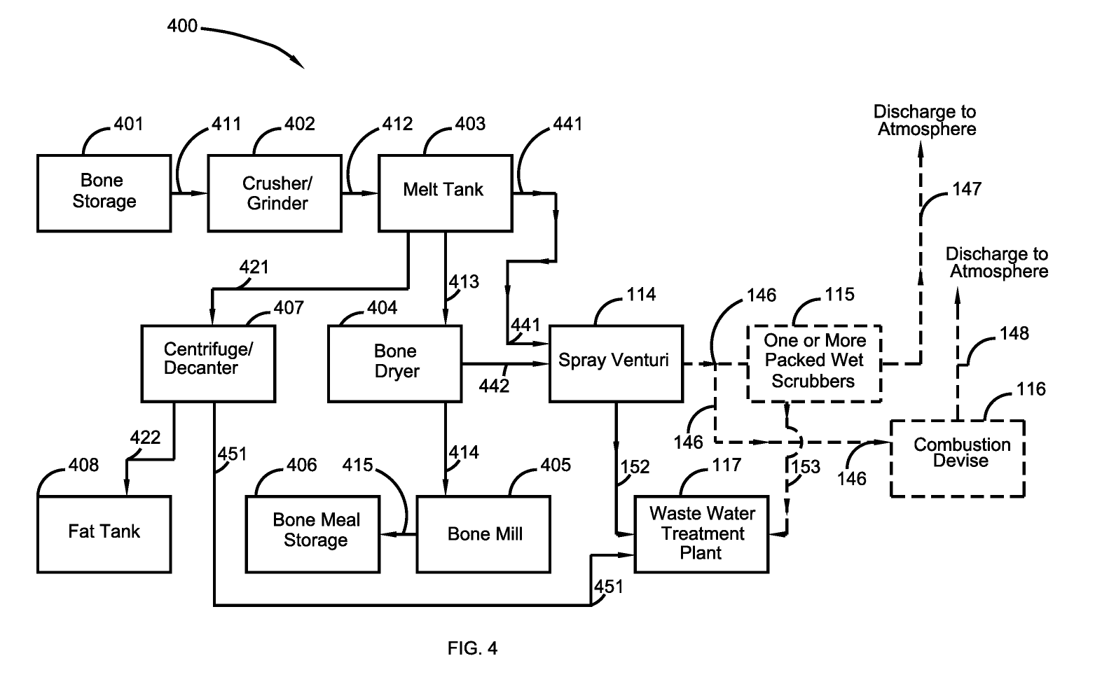

FIG. 4 is a flow diagram for a typical bone rendering process;

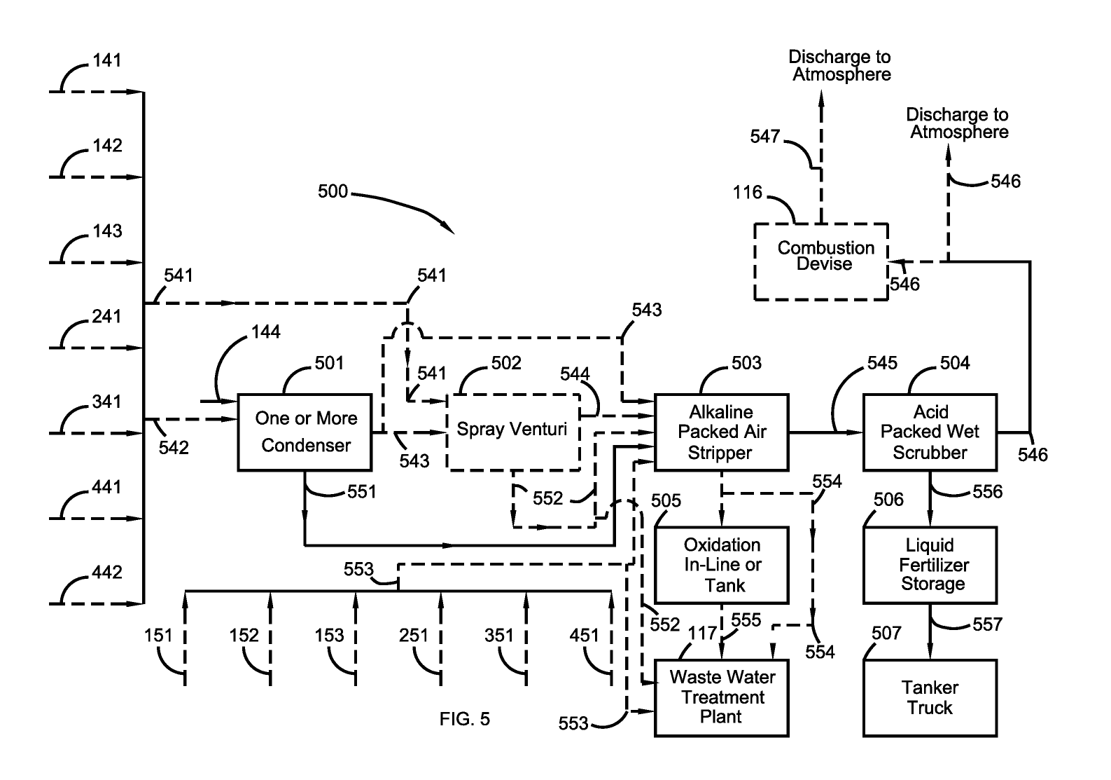

FIG. 5 is a flow diagram for treating various industrial streams according to one embodiment of the present invention;

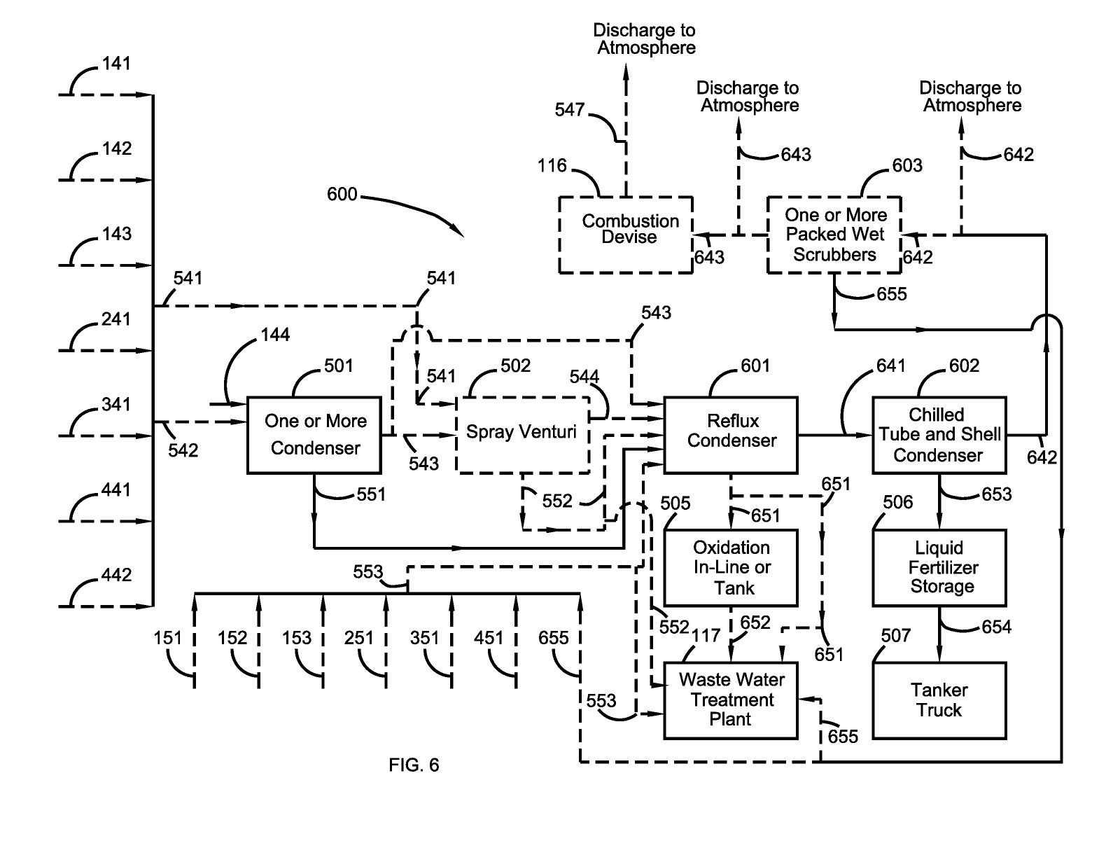

FIG. 6 is a flow diagram for treating various industrial streams according to one embodiment of the present invention;

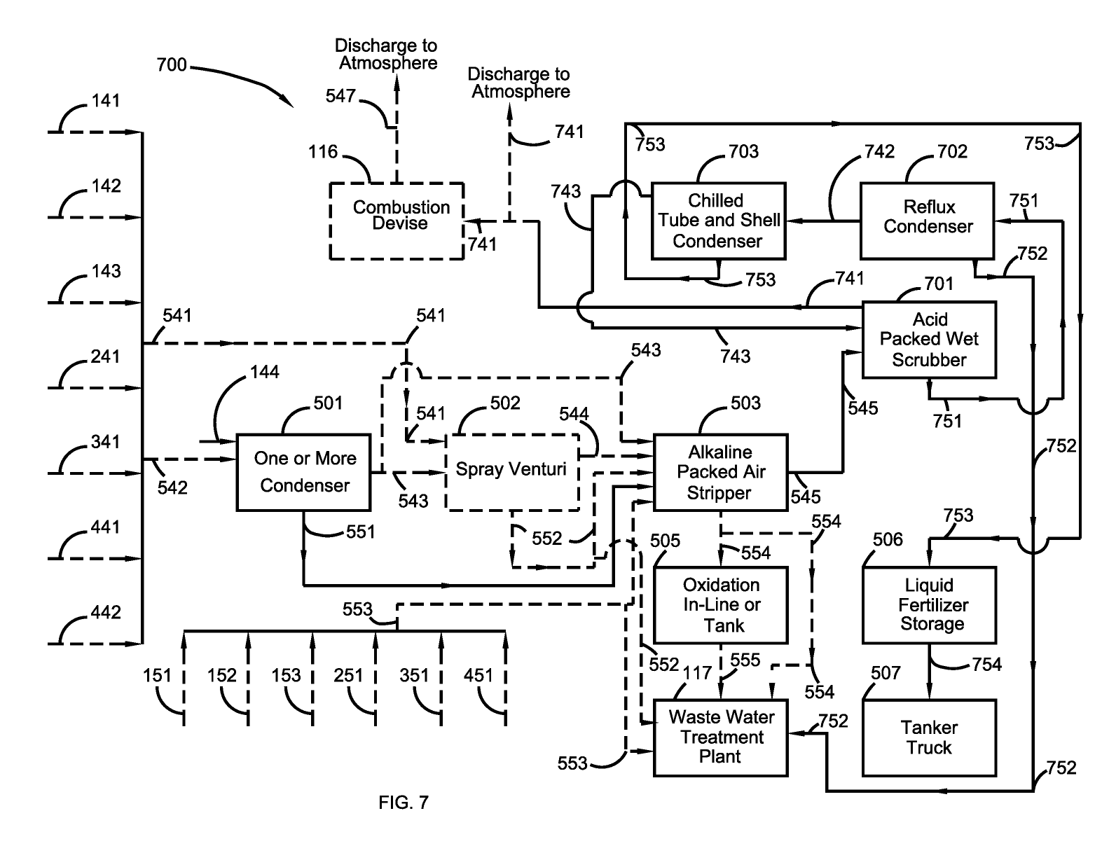

FIG. 7 is a flow diagram for treating various industrial streams according to one embodiment of the present invention;

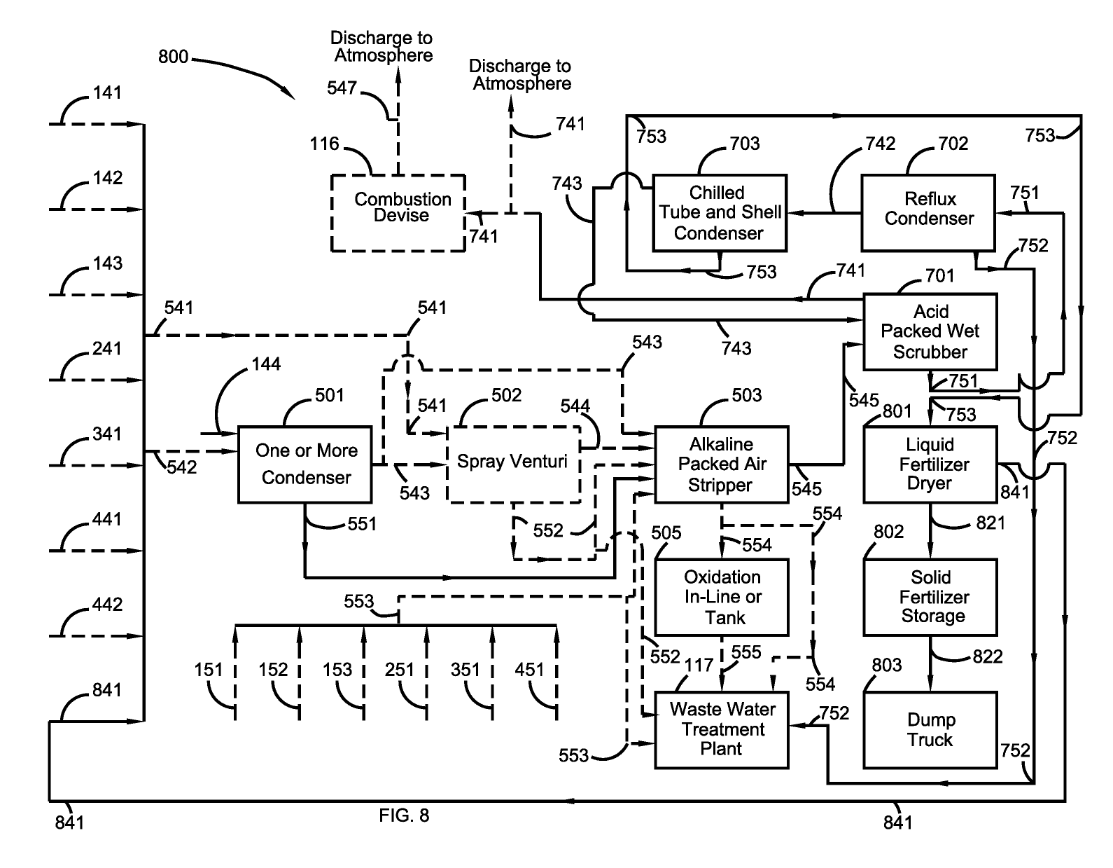

FIG. 8 is a flow diagram for treating various industrial streams according to one embodiment of the present invention;

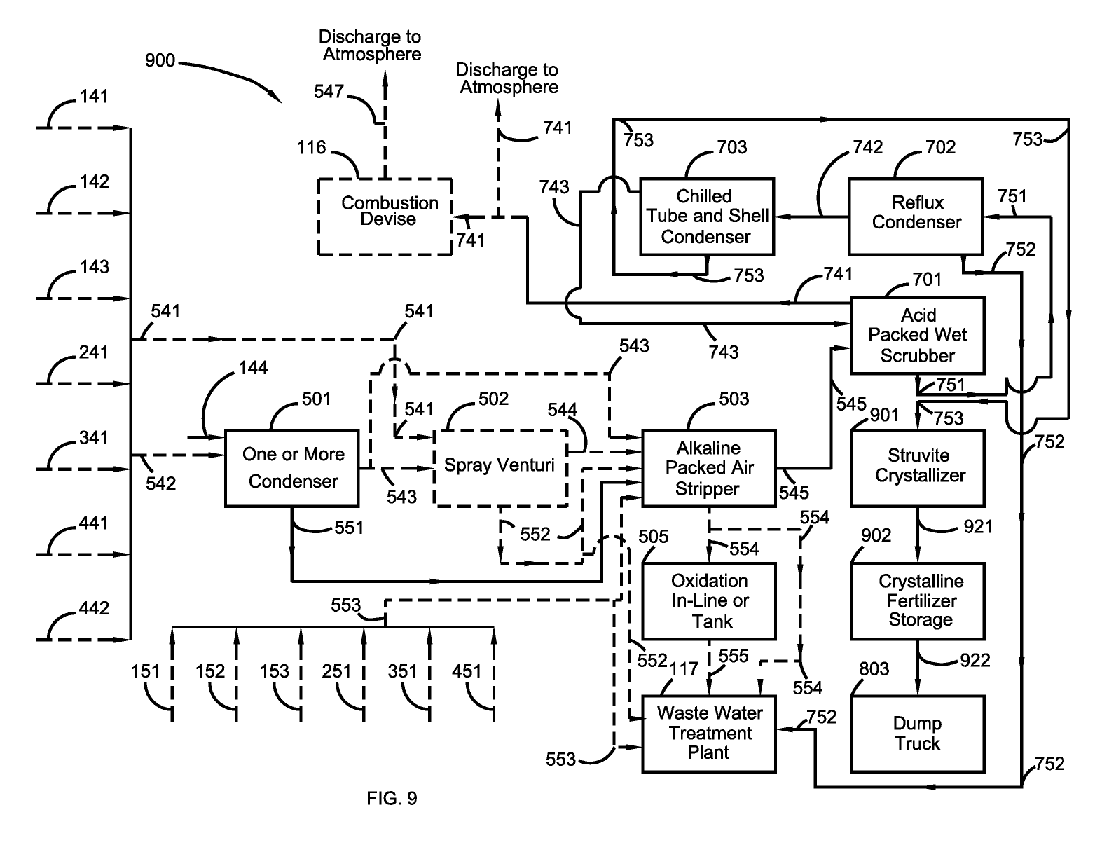

FIG. 9 is a flow diagram for treating various industrial streams according to one embodiment of the present invention; and

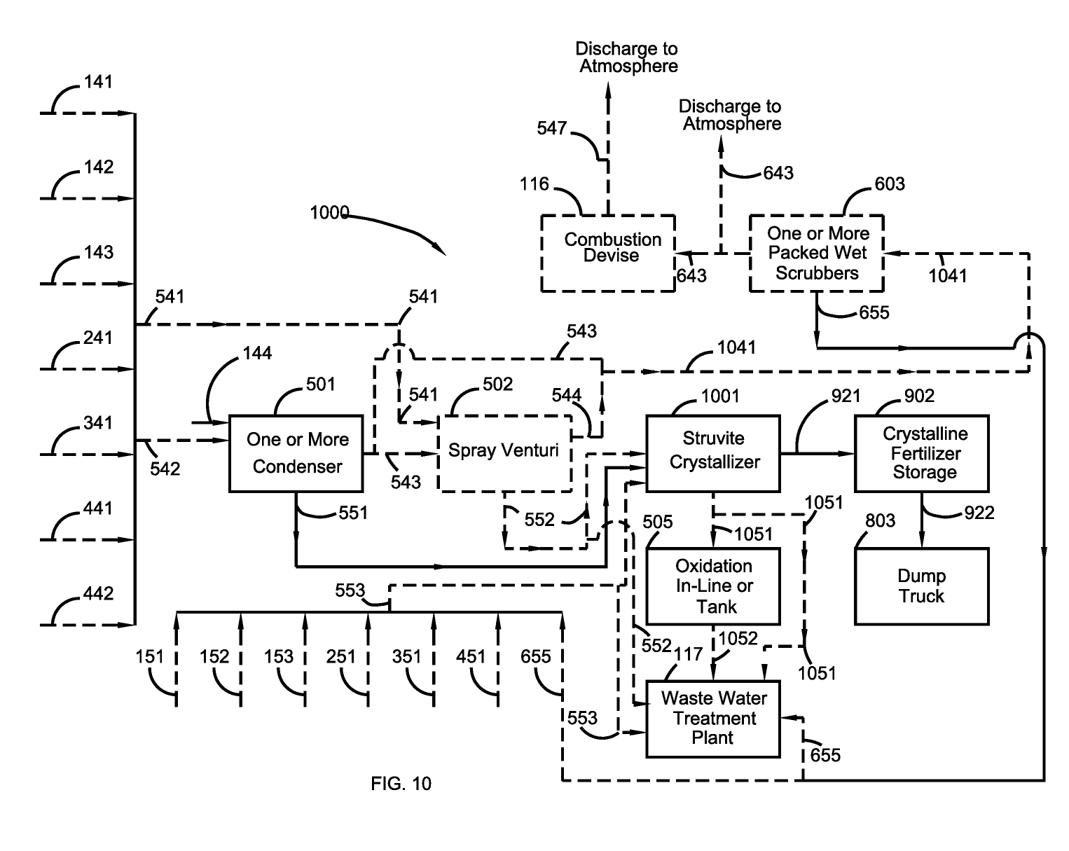

FIG. 10 is a flow diagram for treating various industrial streams according to one embodiment of the present invention.

### DETAILED DESCRIPTION OF THE INVENTION

Various embodiments of the present invention are more fully described below with reference to the accompanying drawing. While the invention will be described in conjunction with particular embodiments, it should be understood that such is exemplary of various embodiments that fall within the scope of the present invention and that alternatives, modifications, and equivalents are also within the scope of the invention. Moreover, the invention can be applied to a wide variety of applications. Accordingly, the following description should not be viewed as limiting or as setting forth the only embodiments of the invention, as the invention encompasses other embodiments not specifically recited in this description. Further, the terms “invention,” “preferably,” and “for example,” are used broadly and are not intended to mean that any particular portion of the description is the only manner in which the invention may be made or used. In fact, various embodiments with common and differing features are described herein.

Generally, the invention and its various embodiments relate to methods and equipment for treating liquid and vapor streams in an industrial process. Broadly, the liquid and vapor streams may be process waste or discharge streams containing various chemicals or compounds. Depending upon the specific composition of the liquid and vapor streams, the treatment process is designed to recover useful chemicals from these streams using various chemical process unit operations. In some embodiments, the chemicals or compounds may be odorous, pollutants, or nutrients. For example, in some industrial processes, such as a rendering process, such liquid and vapor streams may contain ammonia or ammonium that can be recovered to produce a saleable fertilizer product. The liquid streams may be treated separately or combined, depending upon their composition and the desired composition of any ultimate discharge stream and the chemical to be recovered or concentrated. The vapor streams are generally condensed to produce a liquid stream that includes the condensed chemical of interest, which may be treated separately or combined with other liquid streams produced by condensing vapor streams or liquid streams for treatment, depending upon their composition and the desired composition of any ultimate discharge stream and the chemical to be recovered or concentrated.

It should be appreciated that the present invention has application in many different industrial processes. Generally, the methods of the present invention can be applied to any industrial waste or discharge streams, whether liquid or vapor streams. For example, treatable streams exist in the biofuel industry, pet food manufacturing industry, gelatin processes and/or plants, specialty protein processes and/or plants, and animal kill plants. The following description, however, will use a rendering process and the recovery of ammonia or ammonium compounds from various liquid and vapor streams to produce a fertilizer product as exemplary of the invention. It should be appreciated that not only does the invention have application for other industrial processes, but other chemicals may be recovered for purposes of generating other useful or saleable chemical products besides fertilizer.

In some embodiments, the liquid streams may contain dissolved chemical species, suspended solids, colloidal suspensions, and insoluble liquids such as fats, oils, greases, and blood serum, etc.). In some embodiments, the vapor streams may contain commingled gas, liquid, and/or solid phases. Therefore, both the liquid and vapor waste streams, while predominantly liquid and vapor, respectively, may contain multiple phases or components in a different phase. Accordingly, it should be appreciated that reference to liquid streams may be a liquid stream that is predominantly liquid but that may contain other phases such as suspended solids. Similarly, it should be appreciated that reference to vapor streams may be a vapor stream that is predominantly a vapor or gas but that may contain other phases such as suspended solids or particulate or even liquid particles.

In some embodiments, either or both of the liquid and vapor streams may be process waste or discharge streams comprising odorous, noxious, hazardous, toxic, mutagenic, and/or carcinogenic compounds and/or precursor compounds and/or nutrients (including, but not limited to ammonia and/or ammonium) compounds, and one of these compounds may be the chemical of interest that is to be treated, for example, by isolating and concentrating it to produce a given chemical product. Accordingly, it should be appreciated that these compounds may be compounds whose release into the atmosphere is to be reduced, minimized or prevented. Such compounds may be referred to collectively as pollutants. However, it should be appreciated that the invention is not limited to targeting such a compound or pollutant, as other chemical compounds in a vapor or liquid waste stream may be identified for processing according to the present invention.

In some embodiments, one or more vapor dominated multi-phase waste streams is condensed along with at least some of the one or more odorous, noxious, hazardous, toxic, mutagenic, and/or carcinogenic compounds and/or precursor compounds and/or nutrient compounds that may be present in the vapor stream to generate a liquid stream, comprising a condensed form of at least one of the foregoing compounds that is soluble or dissolved in the liquid stream, that is subsequently treated. In some embodiments, the liquid stream is treated using various chemical process steps or unit operations to produce a saleable or useful chemical product by concentrating a given chemical removed from the vapor stream. For example, such a liquid stream may be concentrated or certain compounds in the liquid stream may be precipitated, in either case to produce a chemical product, such as a fertilizer product, either conventional or certified organic. In addition, such treatment may provide pollution control, either as a pretreatment step or as a final treatment step prior to discharge of a given waste stream. In some embodiments, such pollution control is realized through the removal of certain compounds from the treated stream prior to discharge. In other embodiments, pollution control is realized through chemical reaction of a given pollutant, thereby minimizing or avoiding any harmful effects upon discharge.

In some embodiments, one or more liquid multi-phase waste streams containing one or more odorous, noxious, hazardous, toxic, mutagenic, and/or carcinogenic compounds and/or precursor compounds and/or nutrient (including, but not limited to ammonia and/or ammonium) compounds is treated. In some embodiments, the liquid stream is treated using various chemical process steps or unit operations to produce a saleable or useful chemical product. For example, such a liquid stream may be concentrated or certain compounds in the liquid stream may be precipitated, in either case to produce a chemical product, such as a fertilizer product, either conventional or certified organic. In addition, such treatment may provide pollution control, either as a pretreatment step or as a final treatment step prior to discharge. In some embodiments, such pollution control is realized through the removal of certain compounds from the treated stream prior to discharge. In other embodiments, pollution control is realized through chemical reaction of a given pollutant, thereby minimizing or avoiding any harmful effects upon discharge.

In some embodiments, the invention relates to methods and equipment for treating one or more condensate streams generated in a rendering process. For example, the invention can be used to treat condensate streams, either separately or in any combination, generated by a cooker, a dryer, or a hydrolyzer used in the rendering process. Because these condensate streams contain a significant amount of odor, pollutant, and nutrient (including, but not limited to ammonia and/or ammonium) compounds (the latter of which contributes to biological oxygen demand or BOD), they can be a major cause of odor, pollution, and nutrient problems in the surrounding atmosphere, surface water, and groundwater, even after mixing with other liquid streams from the rendering process and after treatment of all of these combined streams prior to discharge. Accordingly, in one embodiment, these condensate streams are treated using an alkaline packed bed air stripper (heat may be optionally added to the condensate) to flash ammonia into a multi-phase vapor dominated stream, thereby isolating hydrogen sulfide, organic compounds, and separate liquid phase fats, oils, and greases. The ammonia flashed into the vapor stream is subsequently made into a liquid, solid, or crystalline chemical and/or fertilizer product. For example, the ammonia flashed into the vapor stream may be condensed, preserved, and concentrated to make the product. By separating the ammonia from the condensate streams, the loading of the odor, pollutant, and nutrient compounds in those condensate streams is significantly reduced. The liquid condensate stream remaining after flashing the ammonia may contain hydrogen sulfide, organic compounds, and separate liquid phase fats oils and greases and may be sent to a wastewater treatment system or pretreated by oxidation prior to discharge to a wastewater treatment system. In some embodiments, the remaining liquid stream may be oxidized to further reduce its odor, pollutant, and BOD loading by adding an oxidizer to the liquid stream, with the optional addition of a catalyst to catalyze the oxidation and the optional addition of a chelating agent for various purposes as described further below. As a result of adding an oxidizer, the odor, pollutant, and BOD loading compounds are oxidized, thereby further reducing the odor, pollutant, and BOD loading in the condensate stream. The oxidized stream may also be fed to a wastewater treatment system or similar system or simply discharged directly to surface water or to a publicly owned wastewater treatment works (POTW).

In other embodiments, the cooker, dryer, and hydrolyzer condensate streams, either separately or in any combination if more than one, may be mixed with one or more other liquid streams from the rendering process and treated in a similar manner as that described above. These other liquid streams may include any liquid stream from the rendering process that is intended to be discharged, as well as other condensate streams from the rendering process containing odor, pollutant and nutrient loading compounds. Accordingly, in one embodiment, the liquid streams can be combined into a combined liquid stream that is treated using an alkaline packed bed air stripper (heat may be optionally added to the condensate) to flash ammonia into a multi-phase vapor dominated stream, thereby isolating hydrogen sulfide, organic compounds, and separate liquid phase fats oils and greases. The ammonia flashed into the vapor stream is subsequently made into a liquid, solid, or crystalline general chemical and/or fertilizer product. For example, the ammonia flashed into the vapor stream may be condensed, preserved, and concentrated to make the product. By separating the ammonia from the combined condensate and liquid waste streams, the odor, pollutant, and nutrient loading compounds are significantly reduced in the combined liquid stream being treated. The liquid stream remaining after flashing the ammonia may contain hydrogen sulfide, organic compounds, and separate liquid phase fats oils and greases and may be sent to a wastewater treatment system or pretreated by oxidation prior to discharge to wastewater treatment system. In some embodiments, the remaining liquid stream may be oxidized to further reduce its odor, pollutant, and BOD loading by adding an oxidizer to the liquid stream, with the optional addition of a catalyst to catalyze the oxidation and the optional addition of a chelating agent for various purposes as described further below.

As a result of adding an oxidizer, the odor, pollutant, and BOD loading compounds are oxidized, thereby further reducing the odor, pollutant, and BOD loading of this remaining liquid stream. The oxidized stream may also be fed to a wastewater treatment system or similar system or simply discharged directly to surface water or to a POTW.

In other embodiments, one or more vapor streams may be condensed to produce a liquid stream that is treated separately or in combination with any of the cooker, dryer, and hydrolyzer condensate streams or any of the one or more other liquid streams from the rendering process. The vapor streams may contain odor, pollutant, and nutrient (including, but not limited to ammonia and/or ammonium) compounds. The condensed vapor stream (i.e., the liquid stream resulting from the condensation of the vapor stream), alone or in combination with any of the other liquid streams, can be similarly treated as described above. These vapor streams may be multi-phase waste streams and may include any vapor stream from the rendering process that is intended to be treated for odor, pollutant, and or nutrient (including, but not limited to ammonia and/or ammonium) compounds prior to discharge to breathing spaces or the atmosphere. Accordingly, in one embodiment, these vapor streams can be condensed separately, or combined into one vapor stream that is condensed, and then further combined with other liquid streams to be treated. During condensation, a chemical of interest is also condensed and transferred to the resulting liquid stream. In some embodiments, the chemical of interest is a pollutant and upon condensation is either soluble in or dissolved in the resulting condensed vapor stream or liquid stream. The condensed vapor stream, with or without the combination of other liquid streams, can be treated using an alkaline packed bed air stripper (heat may be optionally added to the condensate) to flash ammonia into a vapor stream, thereby isolating hydrogen sulfide, organic compounds, and separate liquid phase fats oils and greases. The ammonia flashed into the vapor stream is subsequently made into a liquid, solid, or crystalline general chemical and/or fertilizer product. For example, the ammonia flashed into the vapor stream may be condensed, preserved, and concentrated to make the product. By separating the ammonia from the condensed vapor stream and other combined condensate and liquid waste streams, the odor, pollutant, and nutrient loading compounds are significantly reduced in the liquid stream being treated. The liquid stream remaining after flashing the ammonia may contain hydrogen sulfide, organic compounds, and separate liquid phase fats oils and greases and may be sent to a wastewater treatment system or pretreated by oxidation prior to discharge to wastewater treatment system. In some embodiments, the remaining liquid stream may be oxidized to further reduce its odor, pollutant, and BOD loading by adding an oxidizer to the liquid stream, with the optional addition of a catalyst to catalyze the oxidation and the optional addition of a chelating agent for various purposes as described further below. As a result of adding an oxidizer, the odor, pollutant, and BOD loading compounds are oxidized, thereby reducing the odor, pollutant, and BOD loading of this remaining liquid stream. The oxidized stream may also be fed to a wastewater treatment system or similar system or simply discharged directly to surface water or to a POTW.

Following various embodiments of the present invention are described, including various process configurations as illustrated by the flow diagrams shown in the Figures. It should be appreciated that these various process configurations are exemplary and that various other configurations are possible.

FIG. 1 is a flow diagram for a typical rendering process. The process 100 illustrates a typical dry, continuous rendering process and related liquid streams (that may have comingled dissolved chemical species, suspended solids, colloidal suspensions, and insoluble liquids such as fats, oils, greases, blood serum, etc.) and vapor streams (that may have commingled gas, liquid, and/or solid phases or components), including process waste discharge streams that may be treated or concentrated according to one embodiment of the present invention.

As shown, a truck 101 will typically dump 121 various animal and animal byproduct materials into a storage tank or bin 102. This byproduct material is conveyed 122 for processing in a crusher 103 prior to being conveyed 123 to a cooker 104, which may be a rotary or disk dryer or hydrolyzer, where heat is added to dry the material or to drive-off the water content and to separate the fat from the bone and protein. As a result, the cooker 104 produces a vapor stream 144 and a solids stream 124. The vapor stream 144 may contain odor, pollutant, and nutrient (including, but not limited to ammonia and/or ammonium) compounds.

The vapor stream 144 typically is processed through a condenser 113, which may be an air cooled condenser, a water cooled condenser, a chilled condenser, or any combination of the foregoing, including a series of condensers. The condenser 113 produces a vapor stream 145 and a liquid stream 151. The vapor stream 145 may contain a portion of the odor, pollutant, and nutrient (including, but not limited to ammonia and/or ammonium) compounds and is conveyed to a spray venturi 114 to remove solids, such as particulates, aerosolized fats, and VOCs, and to further condense the vapors. The liquid stream 151 may also contain a portion of the odor, pollutant, and nutrient (including, but not limited to ammonia and/or ammonium) compounds from the condenser 113 and is conveyed to a waste water treatment plant 117. It should be appreciated that the concentrations of the various odor, pollutant, and nutrient compounds in the liquid stream 151 and the vapor stream 145, and the partition between them, will depend upon the composition of the vapor stream 144 fed to the condenser 113 and the operating conditions of the condenser 113.

The solids stream 124 from the cooker 104 is fed into a drainer 105 that produces a fats stream 126, which drains into the fat tank or bin 107 and a separate solids stream 125. The solids stream 125 is fed from the drainer 105 into screw presses 106. A second fats stream 127 is expelled from screw presses 106 and conveyed into the fat tank or bin 107. A third fats stream 129 is conveyed from the fat tank or bin 107 into a centrifuge or filter system 108 that produces a fourth fats stream 130 that is conveyed into an animal fat storage tank or bin 109. The centrifuge or filter system 108 also produces a vapor stream 142 that may contain odor, pollutant, and nutrient (including, but not limited to ammonia and/or ammonium) compounds and is typically vented to the spray venturi 114 to remove solids, such as particulates, aerosolized fats, and VOCs and to further condense the vapors.

A vapor stream 141 generated from the screw presses 106 may contain odor, pollutant, and nutrient (including, but not limited to ammonia and/or ammonium) compounds and is typically vented to the spray venturi 114 to remove solids, such as particulates, aerosolized fats, and VOCs, and to further condense the vapors.

A solids stream 128 generated from the screw presses 106 is conveyed into a grinder 110. From the grinder 110, solids 131 are conveyed to a shaker screen 111. A portion of the solids too large to pass through the shaker screen 111 and are conveyed 132 back to the grinder 110. Solids that pass through the shaker screen 111 are conveyed 133 to a protein meal storage tank or bin 112. The grinder 110 also produces a vapor stream 143 that may contain odor, pollutant, and nutrient (including, but not limited to ammonia and/or ammonium) compounds and is typically vented to room air.

The spray venturi 114, which treats vapor streams from the condenser 145, the centrifuge and/or filter system 142, and the screw presses 141, may contain odor, pollutant and nutrient (including, but not limited to ammonia and/or ammonium) compounds (commonly referred to as “high intensity” vapors) can be optionally vented 146 to one or more packed bed wet air scrubbers 115 for further treatment prior to being vented 147 to the atmosphere. The scrubbers 115 may be used to remove a portion of the remaining odor, pollutant, and nutrient (including, but not limited to ammonia and/or ammonium) compounds in the vapor stream 146 from the spray venturi 114 and frequently contain a chemical and/or temperature treatment and a pH control system to increase the removal efficiency. Excess waters 153 from the wet scrubbers 115 may be conveyed to the waste water treatment plant 117. In some rendering plants, the “high intensity” vapor streams from the spray venturi 114 can be optionally vented 146 to a combustion device 116 prior to discharge 148 to the atmosphere. The combustion device 116 can typically consist of a the firebox of industrial steam boilers, direct fired thermal oxidizer (“TO”), regenerative thermal oxidizer (“RTO”), regenerative catalytic oxidizer (“RCO”), thermal recuperative oxidizer (“TRO”), etc. It should be appreciated that the “high intensity” vapors at rendering plants may be further treated either through one or more packed bed air scrubbers or through one of many types of combustion devices. The pre-treatment of “high intensity” vapors through one or more scrubbers or other types of vapor treatment devices is described in U.S. patent application Ser. No. 14/660,923, filed Mar. 17, 2015, which is incorporated herein by reference in its entirety.

The spray venturi 114 also produces a liquid stream 152 that may contain odor, pollutant, and nutrient (including, but not limited to ammonia and/or ammonium) compounds and is conveyed to the waste water treatment plant 117. The pre-treatment of condensate, spray venturi, and scrubber liquid via oxidation and other types of waste water treatment devices is described in U.S. Pat. No. 8,753,566 B1, granted Jun. 17, 2014, which is incorporated herein by reference in its entirety.

FIG. 2 is a flow diagram for a typical blood rendering process. The process 200 illustrates a blood rendering process including related liquid streams (that may have comingled dissolved chemical species, suspended solids, colloidal suspensions, and insoluble liquids such as fats, oils, greases, blood serum, etc.) and vapor streams (that may have commingled gas, liquid, and/or solid phases or components), including process waste discharge streams that may be treated according to one embodiment of the present invention.

In this process 200, blood is stored in a storage tank or bin 201 and conveyed 211 to a coagulator 202 in which the blood coagulates. The coagulated blood 212 is conveyed to a decanter 203 that separates the coagulated blood 212 into a liquid stream 251 and a protein-rich blood fraction 214. The liquid stream 251 may contain odor, pollutant, and nutrient (including, but not limited to ammonia and/or ammonium) compounds from the waste blood serum. The liquid stream 251 is conveyed to a wastewater treatment plant 117 for treatment prior to discharge. The protein-rich blood fraction 214 from the decanter 203 is conveyed to a blood dryer 204 where it is dried and from which a vapor stream 241 and a stream of dried blood protein 215 are generated. The stream of dried blood protein 215 is conveyed to a blood meal storage tank or bin 205. The vapor stream 241 from the blood dryer 204 may contain odor, pollutant, and nutrient (including, but not limited to ammonia and/or ammonium) compounds and is vented to a spray venturi 114. The spray venturi 114 generates a “high intensity” vapor stream 146 that is optionally vented to one or more packed bed wet air scrubbers 115 for further treatment prior to being vented 147 to the atmosphere, as described above in connection with FIG. 1. Excess waters 153 from the wet scrubbers 115 may be conveyed to the waste water treatment plant 117. In some rendering plants, the “high intensity” vapors 146 from spray venturi 114 can be optionally vented to a combustion device 116, similar to that described above in connection with FIG. 1, prior to discharge 148 to the atmosphere. The spray venturi 114 also produces a condensate stream 152 that may contain odor, pollutant, and nutrient (including, but not limited to ammonia and/or ammonium) compounds and that is fed to the wastewater treatment plant 117.

FIG. 3 is a flow diagram for a typical poultry feather, animal hair, or animal wool rendering process. The process 300 illustrates any of these rendering processes, including related liquid streams (that may have comingled dissolved chemical species, suspended solids, colloidal suspensions, and insoluble liquids such as fats, oils, greases, blood serum, etc.) and vapor streams (that may have commingled gas, liquid, and/or solid phases or components), including process waste discharge streams that may be treated according to one embodiment of the present invention.

In this process 300, poultry feathers, animal hair, or animal wool are stored in a storage tank or bin 301 and conveyed 311 to a dewatering press 302. The dewatering press 302 dewaters the material in the storage tank 301 and generates a liquid stream 351 that may contain odor, pollutant, and nutrient (including, but not limited to ammonia and/or ammonium) compounds and that is conveyed to a wastewater treatment plant 117. The dewatering press 302 also generates a solid stream 312 that is conveyed to a hydrolyzer 303 in which the solids are hydrolyzed. The hydrolyzed solids 313 are conveyed to a dryer 304 in which the hydrolyzed solids 313 are dried. The hydrolyzed and dried solids 314 are conveyed to a mill 305 in which the solids are milled to create a corresponding meal product made from either poultry feathers, animal hair, or animal wool. The meal product 315 is conveyed to a storage tank or bin 306.

The hydrolyzer 303 and the dryer 304 also produce vapor streams 341, 342 that may contain odor, pollutant, and nutrient (including, but not limited to ammonia and/or ammonium) compounds. These vapor streams 341, 342 are vented to a spray venturi 114, which produces a “high intensity” vapor stream 146 that can be optionally vented to one or more packed bed wet air scrubbers 115 for further treatment prior to being vented 147 to the atmosphere, as described above in connection with FIG. 1. Excess waters 153 from the wet scrubbers 115 may be conveyed to the waste water treatment plant 117. In some rendering plants, the “high intensity” vapors 146 from spray venturi 114 can be optionally vented to combustion device 116, similar to that described above in connection with FIG. 1, prior to discharge 148 to the atmosphere. The spray venturi 114 also produces a condensate stream 152 that may contain odor, pollutant, and nutrient (including, but not limited to ammonia and/or ammonium) compounds and that is fed to the wastewater treatment plant 117.

FIG. 4 is a flow diagram for a typical bone rendering process. The process 400 illustrates a typical process configuration for bone rendering, including related liquid streams (that may have comingled dissolved chemical species, suspended solids, colloidal suspensions, and insoluble liquids such as fats, oils, greases, blood serum, etc.) and vapor streams (that may have commingled gas, liquid, and/or solid phases or components), including process waste discharge streams that may be treated according to one embodiment of the present invention.

In this process 400, bones stored in a storage tank or bin 401 are conveyed 411 to a crusher/grinder 402 where the bones are crushed or ground. The crushed/ground bones 412 are conveyed to a melt tank 403 in which the bones are cooked. The cooked bones 413 are conveyed to a bone dryer 404 where the bones are dried. The dried bones 414 are conveyed to a mill 405 to create a bone meal product 415 and then conveyed to a storage tank or bin 406.

The melt tank 403 also generates a mixed liquid stream containing fats, proteins and water 421. This mixed liquid stream 421 is conveyed to a centrifuge/decanter 407. Fats 422 from the centrifuge/decanter 407 are conveyed to the fat tank 408. The centrifuge/decanter 407 also produces a waste liquid stream 451 that contains water, proteins, and other waste products and that is conveyed to the wastewater treatment plant 117.

The melt tank 403 and the dryer 404 each produce vapor streams 441, 442 that may contain odor, pollutant, and nutrient (including, but not limited to ammonia and/or ammonium) compounds that are vented to a spray venturi 114, which produces a “high intensity” vapor stream 146 that can be optionally vented to one or more packed bed wet air scrubbers 115 for further treatment prior to being vented 147 to the atmosphere, as described above in connection with FIG. 1. Excess waters 153 from the wet scrubbers 115 may be conveyed to the waste water treatment plant 117. In some rendering plants, the “high intensity” vapors 146 from spray venturi 114 can be optionally vented to combustion device 116, similar to that described above in connection with FIG. 1, prior to discharge 148 to the atmosphere. The spray venturi 114 also produces a condensate stream 152 that may contain odor, pollutant, and nutrient (including, but not limited to ammonia and/or ammonium) compounds and that is fed to the wastewater treatment plant 117.

FIG. 5 is a flow diagram for treating various industrial streams according to one embodiment of the present invention. The process 500 illustrates a process flow configuration for treating one or more liquid streams and one or more vapor streams according to one embodiment of the present invention. It should be appreciated that the liquid streams may contain comingled dissolved chemical species, suspended solids, colloidal suspensions, and insoluble liquids such as fats, oils, greases, blood serum, etc., and the vapor streams may contain commingled gas, liquid, and/or solid phases. The liquid and vapor streams treated by this process 500 may be any industrial liquid or vapor stream, including waste and discharge streams. In some embodiments, liquid and vapor streams treated by this process 500 may be any of the liquid or vapor streams identified in connection with FIGS. 1-4 above.

Generally, the process 500 uses a series of strippers and scrubbers, which may require heating and/or cooling steps, to separate, treat, or concentrate the odorous, pollutant and nutrient loading compounds in these streams to generate a general liquid chemical product, such as a fertilizer that can be easily stored, sold, and transported offsite for use in industry, such as in the agricultural industry. The present invention simultaneously reduces the primary, high concentration odor, pollutant, and nutrient source otherwise conveyed to an air pollution and odor control system and to the atmosphere and/or breathing spaces. In addition, the present invention and also reduces the loading of odorous, pollutant, and nutrient (including, but not limited to ammonia and/or ammonium) compounds to a wastewater pre-treatment system, an industrial waste water treatment system, or similar system or to a POTW, as well as to surface water and groundwater.

In the process 500, vapors 144 from a cooker used in a rendering process as described above, are conveyed to a series of one or more condensers 501. In additional, other “high intensity” vapor streams (141, 142, 143, 241, 341, 441 and 442, corresponding to and including any of the vapor streams identified above in connection with FIGS. 1-4) may be optionally conveyed 542 to the series of one or more condensers 501. It should be appreciated that any one or more of these streams may be combined into one stream that is fed to the condenser 501. It should also be appreciated that enhanced partitioning of nutrient (including, but not limited to ammonia and/or ammonium) compounds within the condenser 501 to either the liquid or vapor phase can be achieved by adding acid or alkaline agents, respectively.

The condenser 501 generates a liquid condensate stream 551 that may contain odor, pollutant, and nutrient loading compounds and is conveyed to the liquid spray heads of an alkaline packed bed air stripper 503. The liquid condensate stream 551 may optionally be heated to increase the liquid temperature of the condensate up to the boiling point. It should be appreciated that the odor, pollutant, and nutrient loading compounds that are transferred upon condensation in the condenser 501 from the vapor stream to the condensate stream or condensed vapor stream will contain at least a portion of the odor, pollutant, and nutrient loading compounds and that in some embodiments, the odor, pollutant, and nutrient loading compounds will be soluble in or dissolved in the condensate stream.

Additionally, a liquid stream 552 from a spray venturi 502 (described further below) may be optionally conveyed to the liquid spray heads of alkaline packed bed air stripper 503. The liquid stream 552 may optionally be heated to increase the liquid temperature of the condensate up to the boiling point. Additionally, other liquid waste streams (151, 152, 153, 251, 351 and 451, corresponding to and including any of the liquid streams identified above in connection with FIGS. 1-4) may be optionally conveyed as a single feed stream 553 to the liquid spray heads of alkaline packed bed air stripper 503. This liquid stream 553 may optionally be heated to increase the liquid temperature of the condensate above ambient up to the boiling point. It should be appreciated that any one or more of the liquid streams entering the alkaline packed air stripper 503 may be optionally combined in any fashion and fed as one or more streams to the stripper 503 or individually. It should also be appreciated that these other liquid waste streams (151, 152, 153, 251, 351 and 451) may be optionally conveyed as one or more streams 553 to the waste water treatment plant 117.

Ambient air requiring treatment and/or “high intensity” vapor streams (141, 142, 143, 241, 341, 441 and 442) may be optionally conveyed separately or as one or more vapor streams 541 to a spray venturi 502. The spray venturi 502 generates a “high intensity” vapor stream 544 that may contain odor, pollutant, and nutrient loading compounds and that is optionally conveyed to the alkaline packed air stripper 503. The spray venturi 502 also generates a liquid stream 552 that may also contain odor, pollutant, and nutrient loading compounds and that is optionally conveyed to the alkaline packed air stripper 503 or to a wastewater treatment plant 117. The condenser 501 also generates a vapor stream 543 that may contain odor, pollutant, and nutrient loading compounds and that can be optionally conveyed to either the spray venturi 502 or directly to the alkaline packed air stripper 503. Accordingly, it should be appreciated that all of the streams fed to the alkaline packed air scrubber 503 may contain odor, pollutant, and nutrient loading compounds from streams to be treated such that the combination of all of these streams in the alkaline packed air stripper 503 constitute the “air” or “high intensity” vapor flow inside of the stripper 503.

In the alkaline packed air stripper 503, an alkaline pH adjusted liquid waste is circulated in a counter-current fashion to the air or “high intensity vapor” flow inside the alkaline packed bed air stripper 503 to concentrate ammonia in the vapor phase and to concentrate hydrogen sulfide, organic compounds, and separate liquid phase fats, oils, and greases into the liquid phase or the circulating liquid waste stream. In some embodiments, the pH of the liquid reservoir of alkaline packed bed air stripper 503 is adjusted to greater than 7.0, 7.5, 8.0, 8.5, 9.0, 9.2, 9.5, or higher or between 8 and 12. For pH control, any commonly used industrial alkaline solution may be used, including, but not limited to, individual or multiple combined solutions of sodium hydroxide, calcium hydroxide, potassium hydroxide, magnesium hydroxide, etc.

The circulating liquid waste stream containing hydrogen sulfide, organic compounds, and separate liquid phase fats, oils, and greases 554 may be optionally conveyed to an oxidation system (either in-line or a tank) 505 in which components in the liquid are oxidized to produce an oxidized stream 555. Many oxidizers are available for this oxidation step. For example, oxidizers that may be used include, but are not limited to, bromine, chlorine, hypochlorous acid, chlorine dioxide, permanganate, ozone, perhydroxial radical, and hydrogen peroxide alone or hydrogen peroxide and hydroxyl radicals generated by the addition of hydrogen peroxide and a catalyst that catalyzes the decomposition of hydrogen peroxide. It should be appreciated that multiple oxidizers may be used, including any combination of the foregoing named oxidizers. Information regarding the addition of oxidizers and catalysts to oxidize odorous and noxious components absorbed from a gas stream and operation of a gas/liquid contactor used in such a manner is described in U.S. Pat. No. 7,112,309, entitled Method and Apparatus for Use of Reacted Hydrogen Peroxide Compounds in Industrial Process Waters, the entirely of which is incorporated by reference herein. The oxidized stream 555 is conveyed to a wastewater treatment plant 117. It should be appreciated that the circulating liquid waste stream 554 may optionally bypass the oxidation system 505 and be conveyed directly to the onsite wastewater treatment plant 117.

The vapor stream 545 exiting the alkaline packed bed air stripper 503 is concentrated with ammonia and is conveyed to an acid packed bed wet scrubber 504 in which ammonia is removed from the vapor phase into the scrubber solution. In some embodiments, the pH of the liquid reservoir of the acid packed bed air scrubber 504 is adjusted to less than 7.0, 6.5, 6.0, 5.5, or 5.0 or lower or between 6 and 3. For pH control, any commonly used acidic solution may be used, including, but not limited to, individual or multiple combined solutions of nitric acid, hydrochloric acid, sulfuric acid, acetic acid, citric acid, carbonic acid, formic acid, etc. In some embodiments, the scrubber solution make-up water can be fresh or “tap” water available at the plant or facility. In other embodiments, the scrubber solution make-up water can be reclaimed or recycled waste water. In other embodiments, the scrubber solution make-up water can be deionized water. In some embodiments, the scrubber solution can be cooled or chilled below ambient temperature and greater than the freezing point to enhance ammonia solubility, for example, in some embodiments, by lowering the temperature of the scrubber liquid below 30° Celsius and above the freezing point.

A portion of the scrubber solution 556 that is now concentrated with ammonia equal to the volumetric make-up water and acidic solution input to the acid packed bed wet scrubber 504 is conveyed to a liquid general chemical or fertilizer storage tank or bin 506. Periodically, the ammonia concentrated scrubber solution 557 is conveyed to a tanker truck 507 for delivery to a general chemical or fertilizer distributor or manufacturer or to a farm, ranch, or farming cooperative for sale and use as a fertilizer.

A vapor stream 546 exiting the acid packed bed wet scrubber 504 is optionally discharged to the atmosphere or to a combustion device 116 and after combustion, the exhaust 547 is discharged to the atmosphere. The combustion device 116 can be any of the combustion devices described above in connection with FIGS. 1-4.

It should be appreciated that streams containing fats and proteins are subject to foaming. In the present invention, foaming can generally be an issue for multiphase vapor and liquid waste streams containing fats and proteins in which, separately or in combination, air is introduced, the pH is raised, or heat is applied. Foaming can be eliminated or reduced by the addition of anti-foaming agents (including oil-based, powder, water-based, silicone-based, EO/PO-based, alkyl polyacrylates, etc.) or dilution water (including tap water, well water, distilled water, recycled water, process waters, etc.), or by reducing air velocity in those embodiments in which air is being added, pH, or temperature.

FIG. 6 is a flow diagram for treating various industrial streams according to one embodiment of the present invention. The process 600 illustrates a process flow configuration for treating one or more liquid streams and one or more vapor streams according to one embodiment of the present invention. It should be appreciated that the liquid streams may contain comingled dissolved chemical species, suspended solids, colloidal suspensions, and insoluble liquids such as fats, oils, greases, blood serum, etc., and the vapor streams may contain commingled gas, liquid, and/or solid phases. The liquid and vapor streams treated by this process 600 may be any industrial liquid or vapor stream, including waste and discharge streams. In some embodiments, liquid and vapor streams treated by this process 600 may be any of the liquid or vapor streams identified in connection with FIGS. 1-4 above.

Generally, the process 600 uses a series of reflux condensers and/or tube and shell condensers and/or dry condensers, which may require heating and/or cooling steps, to separate, treat, or concentrate the odorous, pollutant and nutrient loading compounds in these streams to generate a general liquid chemical product, such as a fertilizer that can be easily stored, sold, and transported offsite for use in industry, such as in the agricultural industry. The present invention simultaneously reduces the primary, high concentration odor, pollutant, and nutrient source otherwise conveyed to an air pollution and odor control system and to the atmosphere and/or breathing spaces. In addition, the present invention and also reduces the loading of odorous, pollutant, and nutrient (including, but not limited to ammonia and/or ammonium) compounds to a wastewater pre-treatment system, an industrial waste water treatment system, or similar system or to a POTW, as well as to surface water and groundwater.

In the process 600, the process operates as described above in connection with FIG. 5, with certain exceptions. The vapor and liquid streams that may be treated using this process 600 are the same as those described in connection with FIG. 5, including the manner in which these streams are fed to the condenser 501 and the spray venturi 502. However, in this process 600, instead of using an alkaline packed bed air stripper, a reflux condenser 601 is used in its place. The same liquid streams described above in connection with FIG. 5 that are fed to the alkaline packed bed air stripper are instead in this embodiment fed to a liquid reservoir of the reflux condenser 601, which is designed to volatilize ammonia into a gas stream and leave water and other higher boiling point compounds in the liquid reservoir of reflux condenser 601. Also, similarly, enhanced partitioning of nutrient (including, but not limited to ammonia and/or ammonium) compounds within the condenser 501 to either liquid or vapor dominated multi-phase streams can be achieved by adding acid or alkaline agents, respectively.

As described above in connection with FIG. 5, the liquid condensate stream 551 from the condenser 501 may optionally be heated to increase the liquid temperature of the condensate up to the boiling point. Additionally, the liquid waste streams 552 from the spray venturi 502 may be optionally conveyed to the liquid reservoir of a reflux condenser 601. The liquid waste streams 552 from the spray venturi 502 may also optionally be heated to increase the liquid temperature of the condensate up to the boiling point. Additionally, other liquid waste streams (151, 152, 153, 251, 351 and 451) may be optionally conveyed as one or more combined streams 553 to the liquid reservoir of a reflux condenser 601. Similarly, this stream 553 may also optionally be heated to increase the liquid temperature of the condensate up to the boiling point. Similarly, as described in connection with FIG. 5, these other liquid waste streams (151, 152, 153, 251, 351, 451, and 655, which is described further below) may be optionally conveyed as one or more streams 553 to the waste water treatment plant 117.

Ambient air requiring treatment and/or “high intensity” vapor streams (141, 142, 143, 241, 341, 441 and 442) may also be optionally conveyed separately or as one or more combined streams 541 to a spray venturi 502 as described above in connection with FIG. 5 or directly to the reflux condenser 601. The spray venture 502 operates in the same manner as described above in connection with FIG. 5, including the option of passing the “high intensity” vapor stream 544 and/or the liquid stream 552 from the spray venturi 502 to the reflux condenser 601 or passing the liquid stream 552 to a wastewater treatment plant 117.

In the reflux condenser 601 vapor flows up and counter-current to condensate flowing down. As a result of its unique flow characteristics, the reflux condenser 601 can eliminating condensable components from both liquid and vapor streams. The reflux condenser 601 uses an alkaline pH-adjusted liquid that is circulated counter-current to the air or “high intensity” vapor flow inside the reflux condenser 601 to concentrate ammonia to the vapor dominated phase and to concentrate hydrogen sulfide, organic compounds, and separate liquid phase fats, oils, and greases into the liquid phase. In some embodiments, the pH of the liquid reservoir of reflux condenser 601 is adjusted to greater than 7.0, 7.5, 8.0, 8.5, 9.0, 9.2, or 9.5 or higher. For pH control, any commonly used by those familiar in the arts industrial alkaline solution may be used, including, but not limited to, individual or multiple combined solutions of sodium hydroxide, calcium hydroxide, potassium hydroxide, magnesium hydroxide, etc.

The liquid waste stream 651 from the reflux condenser 601 containing hydrogen sulfide, organic compounds, and separate liquid phase fats, oils, and greases may be optionally conveyed to an oxidation system (either in-line or a tank) 505 in which components in the liquid are oxidized to produce an oxidized stream 652 that may be then conveyed to the wastewater treatment plant 117, as described above in connection with FIG. 5. Also, as described above in connection with FIG. 5, the liquid waste stream 651 from the reflux condenser 601 may bypass the oxidation system 505 be conveyed directly to the wastewater treatment plant 117.

The vapor stream 641 concentrated with ammonia created in reflux condenser 601 is conveyed to a chilled tube and shell condenser 602 instead of an acid packed bed wet scrubber as described in connection with FIG. 5. In some embodiments, an acidic solution may be sprayed into the top of the chilled tube and shell condenser 602 to enhance co-condensation of an acidic aqueous solution and ammonia. For example, an acidic solution with pH between 6 and 2 may be sprayed at the head of the chilled tube and shell condenser 602. Any industrial acidic solution may be used, including, but not limited to, individual or multiple combined solutions of nitric acid, hydrochloric acid, sulfuric acid, acetic acid, citric acid, carbonic acid, formic acid, etc. In some embodiments, the make-up water can be fresh or “tap” water available at the plant or facility. In other embodiments, the acidic solution make-up water can be reclaimed or recycled waste water. In other embodiments, the acidic solution make-up water can be deionized water. In some embodiments, the acidic solution make-up water can be recycled condensate from the chilled tube and shell condenser 602. A portion of the condensate solution 653 that is now concentrated with ammonia from the chilled tube and shell condenser 602 is conveyed to a liquid general chemical or fertilizer storage tank or bin 506 and handled in the manner described in connection with FIG. 5.

The vapor stream 642 from the chilled tube and shell condenser 602 is optionally conveyed to the atmosphere or to a series of one or more packed bed wet scrubbers 603. In some embodiments, the first scrubber is an acid packed bed wet scrubber (similar to the acid packed bed wet scrubber 504 in FIG. 5) that may capture additional ammonia in the scrubber liquid. A portion of that scrubber liquid 655 equal to the volumetric make-up water and acidic solution input to the scrubber is optionally conveyed to be blended with other liquid streams and conveyed in one or more streams 553 into the reflux condenser 601. In some embodiments, that same amount of the scrubber liquid may alternatively be conveyed to the wastewater treatment plant 117. It should be appreciated that some of that same portion may be conveyed to both the reflux condenser 601 and the wastewater treatment plant 117.

In some embodiments, a vapor stream 643 from the series of one or more packed bed wet scrubbers 603 is optionally conveyed to the atmosphere or to combustion device 116, and after combustion, the exhaust 547 is discharged to the atmosphere. The combustion device 116 can be any of the combustion devices described above in connection with FIGS. 1-4.

FIG. 7 is a flow diagram for treating various industrial streams according to one embodiment of the present invention. The process 700 illustrates a process flow configuration for treating one or more liquid streams and one or more vapor streams according to one embodiment of the present invention. It should be appreciated that the liquid streams may contain comingled dissolved chemical species, suspended solids, colloidal suspensions, and insoluble liquids such as fats, oils, greases, blood serum, etc., and the vapor streams may contain commingled gas, liquid, and/or solid phases. The liquid and vapor streams treated by this process 700 may be any industrial liquid or vapor stream, including waste and discharge streams. In some embodiments, liquid and vapor streams treated by this process 700 may be any of the liquid or vapor streams identified in connection with FIGS. 1-4 above.

Generally, the process 700 uses a series of reflux condensers and/or tube and shell condensers and/or dry condensers, which may require heating and/or cooling steps, to separate, treat, or concentrate the odorous, pollutant and nutrient loading compounds in these streams to generate a general liquid chemical product, such as a fertilizer that can be easily stored, sold, and transported offsite for use in industry, such as in the agricultural industry. The present invention simultaneously reduces the primary, high concentration odor, pollutant, and nutrient source otherwise conveyed to an air pollution and odor control system and to the atmosphere and/or breathing spaces. In addition, the present invention and also reduces the loading of odorous, pollutant, and nutrient (including, but not limited to ammonia and/or ammonium) compounds to a wastewater pre-treatment system, an industrial waste water treatment system, or similar system or to a POTW, as well as to surface water and groundwater.

The process 700 is the same as that described in connection with FIG. 5 with the exception of the treatment of the streams produced by the acid packed bed wet scrubber (504 in FIG. 5). In this process 700, the acid packed bed wet scrubber 701 produces a liquid stream of scrubber solution 751 that is equal to the volumetric make-up water and acidic solution input to the acid packed bed wet scrubber 701. This portion of the scrubber solution 751 is conveyed to a liquid reservoir of a reflux condenser 702 designed to volatilize ammonia into a gas stream and leave water and other higher boiling point compounds in the liquid reservoir of reflux condenser 702. The portion of the scrubber solution 751 may optionally be heated to increase the liquid temperature of the condensate near the boiling point. In some embodiments, the pH of the liquid reservoir of reflux condenser 702 is adjusted to greater than 7.0, 7.5, 8.0, 8.5, 9.0, 9.2, or 9.5 or higher. For pH control, any commonly used industrial alkaline solution may be used, including, but not limited to, individual or multiple combined solutions of sodium hydroxide, calcium hydroxide, potassium hydroxide, magnesium hydroxide, etc.

A vapor stream 742 concentrated with ammonia created in reflux condenser 702 is conveyed to a chilled tube and shell condenser 703. In some embodiments, an acidic solution may be sprayed into the top of the chilled tube and shell condenser 703 to enhance co-condensation of an acidic aqueous solution and ammonia. For example, an acidic solution with pH between 6 and 2 may be sprayed at the head of the chilled tube and shell condenser 703. Any commonly used industrial acidic solution may be used, including, but not limited to, individual or multiple combined solutions of nitric acid, hydrochloric acid, sulfuric acid, acetic acid, citric acid, carbonic acid, formic acid, etc. In some embodiments, the make-up water can be fresh or “tap” water available at the plant or facility. In other embodiments, the acidic solution make-up water can be reclaimed or recycled waste water. In other embodiments, the acidic solution make-up water can be deionized water. In some embodiments, the acidic solution make-up water can be recycled condensate from the chilled tube and shell condenser 703. A portion of the condensate solution 753 that is now concentrated with ammonia from the chilled tube and shell condenser 703 is conveyed to a liquid general chemical or fertilizer storage tank or bin 506 and handled in the manner as described in connection with FIG. 5. The vapor stream 743 from the chilled tube and shell condenser 703 is conveyed or recycled back to the acid packed bed wet scrubber 701.

In some embodiments, the vapor stream 741 from the acid packed bed wet scrubber 701 is optionally conveyed to the atmosphere or to a combustion device 116, and after combustion, the exhaust 547 is discharged to the atmosphere. The combustion device 116 can be any of the combustion devices described above in connection with FIGS. 1-4.

FIG. 8 is a flow diagram for treating various industrial streams according to one embodiment of the present invention. The process 800 illustrated in FIG. 8 is the same as the described in connection with FIG. 7 with the exception of the processing of the portion of the condensate solution 753 from the chilled tube and shell condenser 703. Instead of passing the condensate solution 753 to a liquid general chemical or fertilizer storage tank or bin 506 as shown in FIG. 7, the condensate solution 753 is passed to a general chemical or fertilizer spray dryer 801 in which the condensate solution 753 is spray dried. It should be appreciated that other methods of drying may be used. The spray dryer 801 generates a vapor stream 841 that may be recycled back to the condenser 501 through optional combination with any vapor streams being fed to the condenser 501. Accordingly, it should be appreciated that the vapor stream 841 from the spray dryer 801 may optionally be recycled directly to the spray venture 502.

The spray dryer 801 produces a dried ammonia salt 821, which may be in the form of a powder, that is passed to a general chemical and/or fertilizer storage tank or bin 802 designed to store powered materials. The powdered material 822 is then conveyed to a dump truck 803 for delivery to a general chemical and/or fertilizer distributor, manufacturer, to a farm, ranch or farming cooperative as described in connection with FIG. 5 with the exception that the material is in powder form as opposed to a liquid form.

FIG. 9 is a flow diagram for treating various industrial streams according to one embodiment of the present invention. The process 900 illustrated in FIG. 9 is the same as the described in connection with FIG. 8 with the exception that instead of using a spray dryer to dry the condensate 753 from the chilled tube and shell condenser 703 to produce a solid or powder ammonia salt 821, a struvite crystallizer 901 is used.

Without being bound by theory, the scientific principle underlying the struvite crystallization process is that struvite (i.e., magnesium ammonium phosphate) can be produced by treating an ammonia-containing liquid stream at an elevated pH and with sufficient concentrations of magnesium and phosphate. In some embodiments, chemicals are added to the liquid stream to simply precipitate struvite. For example, pH adjustments and the addition of magnesium and phosphate is used to achieve an ammonium:magnesium:phosphate molar ratio of approximately 1:1.25:1. In another embodiment, struvite may be precipitated in a fluidized bed pellet reactor consisting of a cylindrical vessel that is partly filled with a suitable seed material. The liquid stream along with the appropriate reaction chemistry or chemicals added are pumped upward through a particle bed to maintain favorable mixing and supersaturation conditions. Effluent overflows at the top, and the pellets progressively grow and sink to the bottom of the vessel. Periodically, pellets are discharged, and the reactor vessel is re-seeded.

Accordingly, the condensate 753 from the chilled tube and shell condenser 703 is added to the struvite crystallizer 901 along with the appropriate reaction chemistry or chemicals required to generate struvite. The struvite crystals or pellets 921 from the struvite crystallizer 901 are conveyed to a general chemical and/or fertilizer storage tank or bin 902 and periodically, the struvite 922 is conveyed to a dump truck 803 for delivery to a general chemical and/or fertilizer distributor, manufacturer, to a farm, ranch or farming cooperative as described in connection with FIG. 5 with the exception that the material is solid or pellet form as opposed to a liquid form.

FIG. 10 is a flow diagram for treating various industrial streams according to one embodiment of the present invention. The process 1000 illustrated in FIG. 10 is the mostly the same as the process 600 described in connection with FIG. 6 with the exception that a struvite crystallizer 1001 is used instead of the reflux condenser 601. Accordingly, the process equipment and steps for the vapor stream 641 produced by the reflux condenser 601 are not required. Rather, the struvite 921 produced by the struvite crystallizer 1001 can be handled in the same manner as that described in connection with FIG. 9, including the use of a general chemical and/or fertilizer storage tank or bin 902 to store the struvite and to periodically convey the struvite 922 to a dump truck 803. In other words, it should be appreciated that all of the liquid streams fed to the reflux condenser 601 as described in connection with FIG. 6, may be fed to the struvite crystallizer 1001. For example, the liquid waste streams 552 from the spray venturi 502 may be optionally conveyed to the struvite crystallizer 1001. Additionally, other liquid waste streams (151, 152, 153, 251, 351 and 451) may be optionally conveyed as one or more streams 553 to struvite crystallizer 1001.

The struvite crystallizer 1001 produces a liquid waste stream 1051 that may optionally be conveyed to an oxidation system (either in-line or a tank) 505, with the discharge 1052 from the oxidation system 505 being passed to a wastewater treatment plant 117 as described in connection with FIG. 5. Alternatively, the liquid waste stream 1051 from the struvite crystallizer 1001 may bypass the oxidation system 505 and be passed directly to the wastewater treatment plant 117 as described in connection with FIG. 5.

However, it should be appreciated that vapor streams to be treated are not fed to the struvite crystallizer 1001. For example, the vapor stream 543, which was a vapor stream exiting the condenser 501, that was optionally fed directly to the reflux condenser 601 in the process 600 as described in connection with FIG. 6, is not fed to the struvite crystallizer 1001. Also, the vapor stream 544 that exits the spray venture 502 in the process 600 as described in connection with FIG. 6, and that was also optionally fed to the reflux condenser 601 is similarly not fed to the struvite crystallizer 1001. Instead, these vapor streams 543, 544 are combined and fed to one or more packed wet scrubbers 603, which are operated in the same manner as described in connection with FIG. 6 with the exception that a vapor stream 642 from a chilled tube and shell condenser 602 was fed to the wet scrubbers 603 in the process 600 described in connection with FIG. 6. The streams generated by the wet scrubbers 603, however, are processed in the same manner as described in connection with FIG. 6.

It should be appreciated that through the use of the invention and the foregoing embodiments, that a reduction in the odorous, noxious, hazardous, toxic, mutagenic, and/or carcinogenic compounds and/or precursor compounds discharged from the industrial process is realized. In addition, in some embodiments, discharges from a given industrial process will have lower amounts of nitrogen, nutrients that increase BOD, phosphorous, total suspended solids, and total oil and grease. In addition, the discharge of particulates may be reduced, including, for example, PM2.5 and PM10 particles. Further, reductions in discharges of air pollution and ozone precursors (e.g. nitrogen oxides (NOₓ), sulfur oxide (SOₓ) may be realized. Accordingly, any regulatory limits on discharges may be more easily met.

While the foregoing description has generally been in the context of one or more liquid multi-phase condensate streams, one or more liquid multi-phase waste streams, and one or more vapor multi-phase waste streams in a rendering facility, it should be appreciated that the process and methods described herein may have application in treating other liquid streams containing odor, pollutant, and nutrient (including, but not limited to ammonia and/or ammonium) compounds. For example, such streams exist in the biofuel industry, pet food manufacturing industry, gelatin processes and/or plants, specialty protein processes and/or plants, and animal kill plants, and these streams can be similarly treated using the various embodiments of the invention described herein. Therefore, the foregoing description should not be viewed as limited to the rendering industry or any particular liquid or vapor stream and may have application for any liquid or vapor stream generated by a process that has an odor, pollutant, and nutrient compound load that is condensable and that can be concentrated into a general chemical product, such as a fertilizer product, such as oil recovery and refining processes. Also, in the embodiments of the current invention that include rendering plant waste nutrient sources, meat by-products and waste are allowed by the Organic Materials Review Institute (OMRI) as long as the wastes are not treated with prohibited materials such as synthetic colorings or solvents that are not on the National List for use in fertilizers and soil amendments. Therefore, in some embodiments of the present invention, the general chemical and/or fertilizer product generated can be sold as organic at a premium value.

What is claimed is:

1. A method for treating a vapor waste stream to produce a chemical product, comprising:
condensing at least one vapor waste stream comprising a pollutant generated by an industrial process to produce a liquid stream comprising the pollutant;
separating the pollutant from the liquid stream; and
concentrating the pollutant to produce a chemical product.

2. The method of claim 1, further comprising:
combining the liquid stream with a second liquid stream comprising a liquid waste stream comprising the pollutant prior to said separating.

3. The method of claim 1, further comprising:
condensing a second vapor waste stream comprising the pollutant; and
combining the at least one vapor waste stream with the second vapor waste stream prior to said condensing.

4. The method of claim 1, further comprising:
separating solids from the liquid stream prior to said separating the pollutant from the liquid stream.

5. The method of claim 1, wherein said separating comprises transferring the pollutant from the liquid stream to a gas stream, and further comprising:
transferring the pollutant from the gas steam to a second liquid stream, wherein the chemical product comprises the second liquid stream.

6. The method of claim 1, wherein said separating comprises transferring the pollutant from the liquid stream to a gas stream, and further comprising:
condensing the gas stream to produce a second liquid stream comprising the pollutant; and
drying the second liquid stream to produce a solid pollutant, wherein the chemical product comprises the solid pollutant.

7. The method of claim 1, wherein said separating comprises transferring the pollutant from the liquid stream to a gas stream, and further comprising:
condensing the gas stream to produce a second liquid stream comprising the pollutant; and
precipitating the pollutant from the second liquid stream to produce a precipitated pollutant, wherein the chemical product comprises the precipitated pollutant.

8. The method of claim 7, wherein the pollutant is an ammonia or ammonium compound and wherein said precipitating precipitates struvite.

9. The method of claim 1, wherein said separating comprises separating the pollutant from the liquid stream using an alkaline packed bed stripper.

10. The method of claim 1, wherein said separating comprises separating the pollutant from the liquid stream using a reflux condenser.

11. The method of claim 1, wherein said separating and said concentrating comprise precipitating the pollutant from the liquid stream to produce a precipitated pollutant and wherein the chemical product comprises the precipitated pollutant.

12. The method of claim 11, wherein the pollutant is an ammonia or ammonium compound and wherein said precipitating precipitates struvite.

13. The method of claim 1, wherein the at least one vapor waste stream comprises a vapor stream generated in a rendering process.

14. The method of claim 1, wherein the pollutant is an ammonia or ammonium compound and the chemical product comprises a fertilizer.
